(19) United States
(12) Patent Application Publication
(10) Pub. No.: US 2010/0083268 A1
(43) Pub. Date: Apr. 1, 2010

(54) Method And System For Managing Access To A Resource By A Process Processing A Media Stream

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/240,202

(22) Filed: Sep. 29, 2008

(51) Int. Cl. G06F 9/46

(52) U.S. Cl. 718/104

(57) ABSTRACT

Methods, systems and computer program products are described for managing access to a resource. In one aspect, a method includes detecting, during processing of a first media stream by a first process for presentation, an association between a concurrency policy and a shared resource shareable with a second process, and then listening for a message providing access to the shared resource based on an evaluation of the concurrency policy. In response to receiving a message providing access to the shared resource, the method includes accessing the shared resource.

### COPYRIGHT NOTICE

A portion of the disclosure of this patent document contains material which is subject to copyright protection. The copyright owner has no objection to the facsimile reproduction by anyone of the Patent and Trademark Office patent file or records, but otherwise reserves all copyright rights whatsoever.

### BACKGROUND

Some resources accessible within a computing environment including a network computing environment are shared by more than one process in the computing environment. For example, a variable within an application can be accessed by more than one thread in the application and/or by more than one application instance. In some instances, a resource can be accessed by multiple concurrent or overlapping processes or threads that read the resource. In this case, the shared resource can be available to any of the processes or threads without restriction. In other instances, a shared resource can be accessed by only a single process/thread at one time, such as a shared resource that is updatable by one of more processes. The terms process and thread are used interchangeably within this document. For example, when a database is written to, it can be locked for a write operation allowing access to only the writing process until the operation is completed. In this case, when multiple processes wish to access the shared resource, the order in which each process is granted access must be controlled.

The process of controlling the order of access to a shared resource is referred to as concurrency control. Unlike access control, which determines whether access is authorized, concurrency control determines the order of access to a shared resource by multiple processes of execution, as well as the number of processes that can access the resource at any given time. In other words, concurrency control is not related to whether a process can access a resource or what it can do with the resource; rather; it determines when a process can access a shared resource.

Concurrency control is typically coded into software at the source code level. Such control is implemented using language specific means, e.g., Java's “serialized” keyword, and system provided functions in an object code library with language specific APIs that perform operations on “locks” and/or “semaphores” when called by a program, and through software transactional memory that also requires language specific features.

### SUMMARY

Methods, systems and computer program products are described for managing access to a resource. While a media stream (e.g., a data stream) can be a shared resource, media streams can also be considered to be streams of execution that can share resources. The sharing of resources between and/or among media streams enables the media streams to interact with, and be responsive to, one another. Enabling media streams to identify and provide for accessing shared resources eliminates the need to provide a software program specifically written to provide interaction between the media streams. In one aspect, a method and a computer readable medium containing a computer program, executable by a machine, for managing access to a resource includes executable instructions for detecting, during processing of a first media stream by a first process for presentation, an association between a concurrency policy and a shared resource shareable with a second process, listening for a message providing access to the shared resource based on an evaluation of the concurrency policy, and receiving a message providing access to the shared resource. The method also includes accessing the shared resource.

In another aspect of the subject matter disclosed herein, another method and a computer readable medium containing a computer program, executable by a machine, for managing access to a resource includes executable instructions for detecting a change in access by a process to a shared resource, and evaluating a concurrency policy controlling an order of access to the shared resource. Based on the concurrency policy, a next process of at least one process processing a media stream and waiting to be allowed access to the shared resource is determined. The method further includes providing for access to the shared resource to the determined next process for processing the media stream including accessing the shared resource.

In another aspect of the subject matter disclosed herein, a system for managing access to a resource includes a concurrency agent configured for detecting, during processing of a first media stream by a first process for presentation, an association between a concurrency policy and a shared resource shareable with a second process, a message receiver configured for listening for and for receiving a message providing access to the shared resource based on an evaluation of the concurrency policy, and a media processing module configured for accessing the shared resource in response to receiving the message.

In another aspect of the subject matter disclosed herein, another system for managing access to a resource includes a resource monitor configured for detecting a change in access by a process to a shared resource, a policy handler configured for evaluating on a concurrency policy controlling an order of access to the shared resource, a concurrency queue manager configured for determining, based on the concurrency policy, a next process of at least one process processing a media stream and waiting to be allowed access to the shared resource, and a control manager configured for providing for access to the shared resource to the determined next process for processing the media stream including accessing the shared resource.

### BRIEF DESCRIPTION OF THE DRAWINGS

Advantages of the subject matter claimed will become apparent to those skilled in the art upon reading this description in conjunction with the accompanying drawings, in which like reference numerals have been used to designate like elements, and in which:

FIG. 1 is a flow diagram illustrating a method for managing access to a resource according to an exemplary embodiment;

FIG. 2 is a block diagram illustrating a system for managing access to a resource according to an exemplary embodiment;

FIG. 3 is a block diagram illustrating another system for managing access to a resource according to another exemplary embodiment;

FIG. 4 illustrates a network in which a system for managing access to a resource can be implemented;

FIG. 5 is a block diagram illustrating another system for managing access to a resource according to another exemplary embodiment;

FIG. 6 is a flow diagram illustrating another method for managing access to a resource according to another exemplary embodiment;

FIG. 7 is a block diagram illustrating a system for implementing the method of FIG. 6 according to an exemplary embodiment;

FIG. 8 is a block diagram illustrating another system for implementing the method of FIG. 6 according to another exemplary embodiment; and

FIG. 9 is a block diagram illustrating another system for managing access to a resource according to another exemplary embodiment.

### DETAILED DESCRIPTION

Various aspects will now be described in connection with exemplary embodiments, including certain aspects described in terms of sequences of actions that can be performed by elements of a computing device or system. For example, it will be recognized that in each of the embodiments, at least some of the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described.

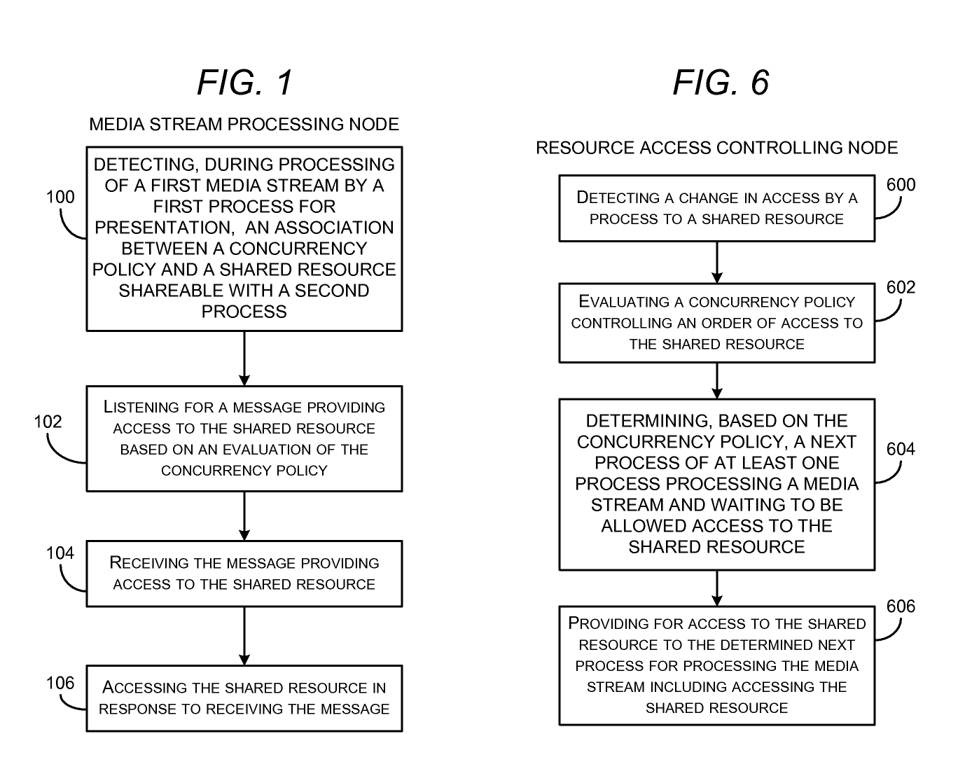

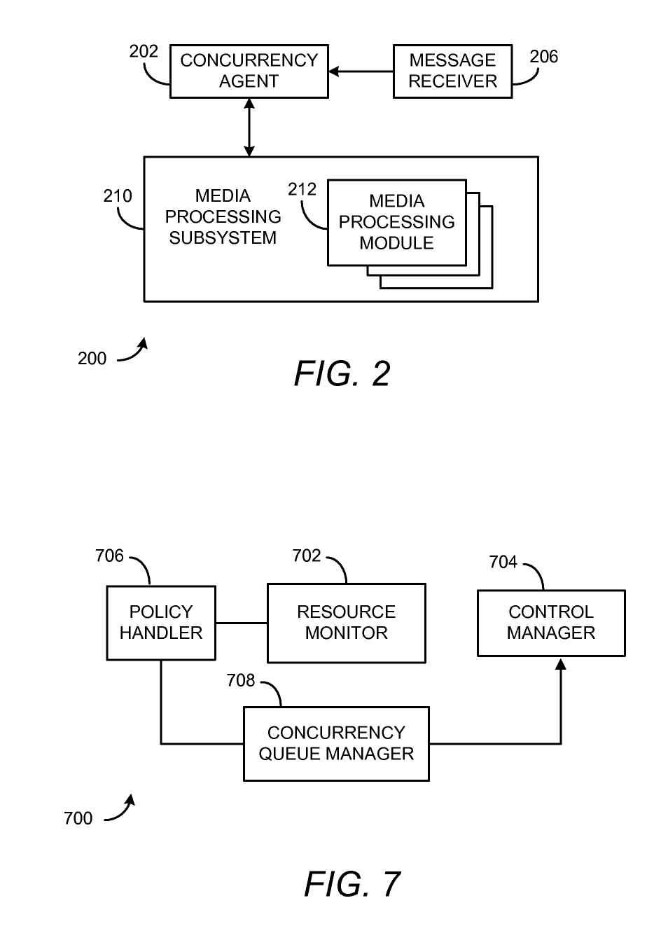

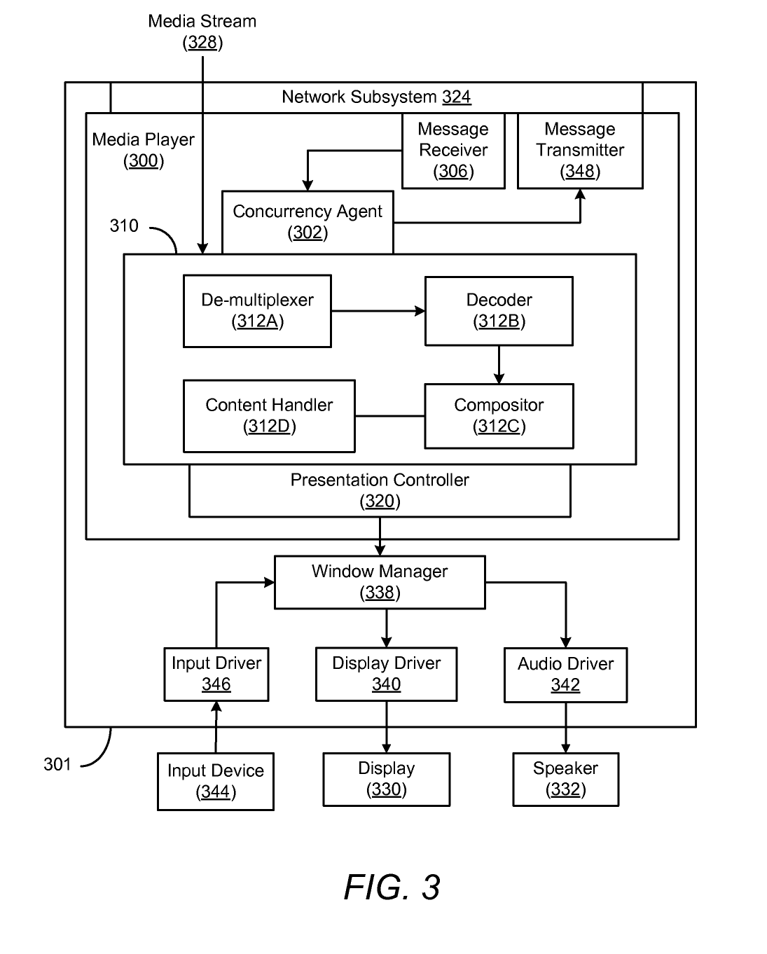

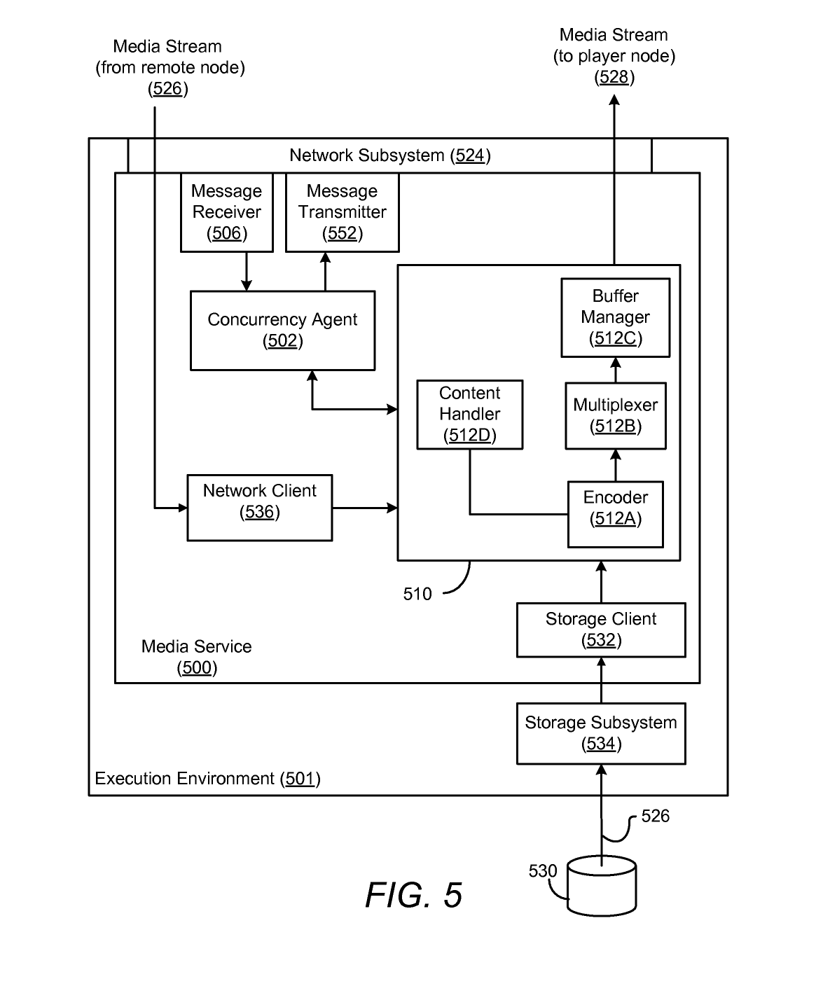

FIG. 1 is a flow diagram illustrating a method for managing access to a resource according to an exemplary embodiment. FIGS. 2, 3, and 5 are block diagrams illustrating systems for managing access to a resource according to embodiments of the subject matter described herein. In particular, FIG. 2 illustrates an arrangement of components configured for managing access to a resource, while FIG. 3 and FIG. 5 illustrate media processing nodes hosting the arrangement of components for managing access to a resource. The method illustrated in FIG. 1 can be carried out by, for example, at least some of the components in each of the exemplary arrangements of components illustrated in FIGS. 2, 3, and 5.

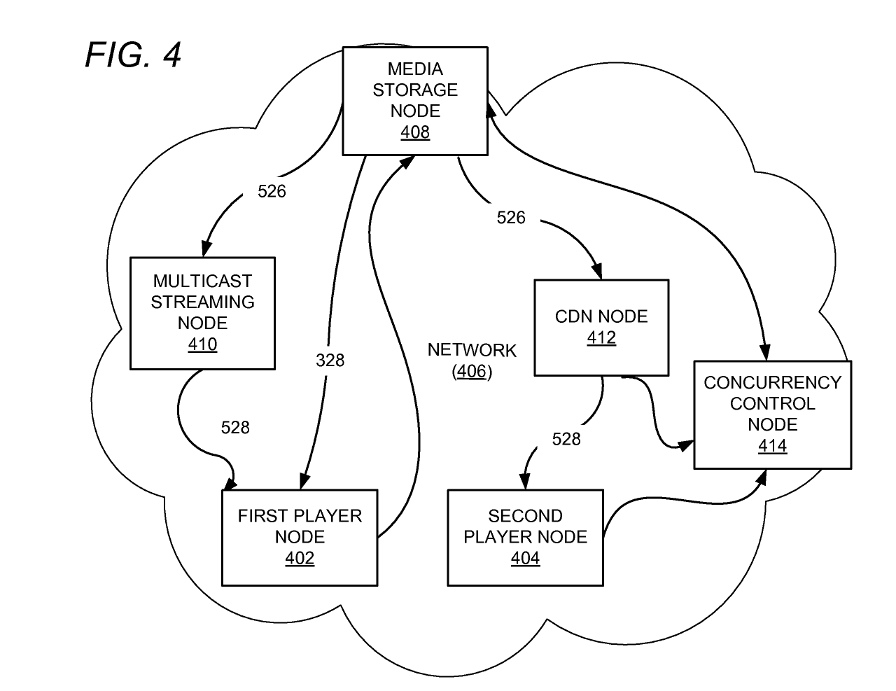

FIG. 2 illustrates an arrangement of components 200 that is configured to operate within an execution environment hosted by a node and/or multiple nodes, as in a distributed execution environment. For example, in FIG. 4, which illustrates a plurality of nodes communicatively coupled to one another via a network 406, such as the Internet, media player nodes 402, 404 and media streaming nodes 408, 410, 412 (collectively referred to as “media processing nodes”) can be configured to provide respective execution environments adapted to support the operation of the arrangement of components 200 in FIG. 2. Exemplary media processing nodes can include desktop computers, servers, networking nodes, notebook computers, PDAs, mobile phones, and digital image capture devices.

An exemplary execution environment can include a memory for storing components and an instruction processing component, such as processor and/or a digital signal processor (DSP), for processing instructions and any data associated with the operation of the components 200. The arrangement of components 200, and functionally analogous arrangements of components, each can require additional hardware and/or software subsystems according to their particular operational requirements. For example, a network subsystem can be included in the execution environment for enabling communication between nodes over the network 406. An operating system, a persistent data storage subsystem, a memory management subsystem, and/or a process scheduler are other examples of components that can be required for various adaptations of the arrangement of components 200 and its functional analogs for performing the method in FIG. 1.

Illustrated in FIG. 3 is a media processing node that provides an execution environment 301 hosting a media player 300 including the arrangement of components 200 illustrated in FIG. 2. The execution environment 301, or an analog, can be provided by a node such as the first player node 402 and/or the second player node 404. Alternatively or in addition, in FIG. 5, the arrangement of components 200 can be adapted for operation within a media processing node that provides an execution environment 501 hosting a media service 500. In this embodiment, the execution environment 501, or an analog, can be provided by a node such as the media storage node 408, the multicast stream node 410, the content delivery network (CDN) node 412, and/or node hosting a media streaming service.

With reference to FIG. 1, in block 100 an association between a concurrency policy and a shared resource is detected by a first process processing a first media stream. In one embodiment, the shared resource is shareable with a second process and can include a media object, an executable resource, a markup-language based resource, and/or another type of resource. The concurrency policy, in one embodiment, determines an order of access to the shared resource for a plurality of processes accessing the shared resource.

According to an exemplary embodiment, a system for managing access to a resource includes means for detecting, during processing of the first media stream by the first process for presentation, the association between the concurrency policy and the shared resource shareable with the second process. For example, FIG. 2 depicts a concurrency agent 202 configured for detecting the association between the concurrency policy and the shared resource during processing of the first media stream by the first process for presentation.

According to an exemplary embodiment, the concurrency agent 202 can detect the association, for example, when it is invoked by a component operating in the first process, and/or when it polls a component operating in the first process. Alternatively, the detecting can be in response to communication by an interprocess communication mechanism provided by an execution environment, such as a message queue, a pipe, and/or an interrupt. The detecting can either directly and/or indirectly indicate an association between a resource to be accessed in processing the first media stream and a concurrency policy. For example, the first process can process an instruction invoking the concurrency agent 202 and identifying a lock representing an association between a concurrency policy and a resource to be accessed during processing of the first media stream.

In one exemplary embodiment, an attempt to access a resource associated with a concurrency policy can be detected by, for example, a component configured to intercept resource access attempts. The intercepting component can be invoked via an interrupt configured to interrupt the processing of the first media stream when an attempt to access the resource is detected. The intercepting component can be configured to be an interrupt handler of the particular interrupt associated with the access attempt. Those skilled in the art will appreciate that the examples just provided are intended to teach, illustrate, and suggest other mechanisms.

According to one embodiment, the concurrency agent 202 can be integrated with a media player 300 and configured to detect the association between a concurrency policy and a resource when the media player 300 is processing a media stream 328 for presentation. In this embodiment, the media player 300 is hosted by an execution environment 301 provided by a media stream processing node, such as the first player node, e.g., 402.

The media player 300 can receive the media stream 328 via a network interface of a network subsystem 324 provided by the execution environment 301. In one embodiment, the media stream 328 can be transmitted over the a network 406 from a media storage node 408, and/or a proxy for the media storage node 408, such as a multicast streaming node 410 or a content delivery network (CDN) node 412. The CDN node 412 can be configured to maintain a cache storing at least a portion of the media stream 328 for transmitting to the first player node 402, the second player node 404, and/or another node (not shown) for processing. Alternatively, the media player 300 can receive the media stream 328 from another node, such as a peer node in a peer-to-peer (P2P) network or another player node, e.g., the second player node 404. In another embodiment, the media stream 328 can be read from a local or remote data store (not shown) and/or provided by another instance of an application (not shown) operating in the execution environment 301.

The media stream 328 can be transmitted in a format suitable for presentation, but is typically transmitted in a format suited for sending over the network 406. Frames in the media stream 328 can be multiplexed into portions corresponding to one or more sub-streams included in the media stream 328. The data can further be encoded for transmission. For example, media stream data transmitted over the network 406 can be in a compressed format. When the media stream 328 is received, the network subsystem 324 can be configured to route media stream data to the media player 300 for processing for presentation on one or more presentation devices, such as a display 330 and/or a speaker 332.

In one embodiment, the system for managing access to a resource includes a media processing subsystem 210 that comprises a plurality of media processing modules 212 for processing media stream data 328. For example, when implemented in the media player 300, media processing modules of the media processing subsystem 310 can include a de-multiplexer 312A, at least one decoder 312B, a compositor 312C, and at least one content handler 312D.

The de-multiplexer 312A can be configured to separate media stream data 328 according to one or more sub-streams, headers (if any), and/or trailers (if any). The de-multiplexer 312A can be further configured to provide data for each sub-stream to a decoder 312B compatible with the sub-stream type. Type can be based on a data format and/or a purpose of a sub-stream. Accordingly, the media player 300 can include and/or have access to at least one decoder 312B for each of video data, audio data, metadata, markup-based language data, e.g., X3D formatted data, and/or script data as well as other types of executable data. Each decoder 312B can be configured to decode encoded data, if required. For example, encoded data can require decoding via decryption and/or decompression.

The compositor 312C can be configured to process synchronization data in the media stream 328 to synchronize the presentation of the various sub-streams of the media stream 328. The media stream 328 can include a synchronization sub-stream. Alternatively or in addition, each particular sub-stream can include synchronization data according to its content for synchronization with other sub-streams including corresponding synchronization data. Alternatively, synchronization data can be included in header and/or trailer data. Sub-stream data from one or more decoders 312B can be received and processed by the compositor 312C for presentation according to any synchronization.

The content handler 312D is configured for processing a particular type of content for presentation. Multiple content handlers 312D can be provided to process different types of data and/or a single content handler 312D can be configured to process at least one type of media stream content. For example, a video sub-stream can be provided to a content handler 312D configured to process a particular type of video corresponding to the video sub-stream. Alternatively, a video content handler 312D can be configured to process multiple video data formats identifiable by MIME type. Additionally or alternatively, one or more audio content handlers 312D can be included, a content handler 312D for ECMAScript or other executable data type, and one or more content handlers 312D configured to process one or more types of markup language based data.

The content handler 312D can provide processed data to the compositor 312C for presenting via a presentation controller 320 and/or can be configured to present processed data as managed by the compositor 312C, for example, by interoperating with the presentation controller 320 without passing the processed data through the compositor 312C. The presentation controller 320 can be configured to interoperate with a window manager 338 provided by the execution environment 301. In particular, an interactive media steam 328 can be presented through capabilities included in the window manager 338.

The window manager 338 can provide access to various device drivers and hardware adapters to access output devices. For example, a display driver 340 can be configured for presenting any visual data included in the media stream 328 on the display 330 via a graphics adapter (not shown), and an audio driver 342 can be configured for presenting any audio data included in the media stream 328 on the speaker 332 via a sound card (not shown). In addition, the window manager 338 can receive input data from an input device 344 via a compatible input driver 346. The window manager 338 can determine to which application and/or application component to provide the input data for processing.

In one embodiment, the detection of the association between a resource to be accessed and a concurrency policy can be based on the processing of an indicator by a process processing the media stream 328. In one embodiment, any of the media processing modules 212 can be configured to process an instruction and/or an indicator to access a shared resource. Furthermore, any of the media processing modules 212 can also be configured to process an indication or instruction to provide and/or otherwise identify concurrency information.

For example, the media stream 328 or a sub-stream of the media stream 328 can include the indicator, which provides an indication to access a shared resource. In addition, the indicator can also identify a concurrency policy and/or the resource. The concurrency policy can include, in one embodiment, a lock, semaphore, remote executable, and/or an expression to be evaluated to determine an order of access for processes accessing the associated resource. In addition, the concurrency policy can include a policy that restricts a number of processes accessing the resource concurrently, a transaction based policy, and/or a transactional memory policy.

The indicator can, in one embodiment, include executable data, such as a script instruction. Exemplary media formats capable of including a scripting language instruction include Advanced Systems Format (ASF) and MPEG-4. MPEG-4 Binary Format for Scenes (BIFS) supports a script stream (ECMAScript). Exemplary scripting languages includable in a media stream include Avisynth compatible with any media player that supports audio video interleave (AVI) formatted streams, Adobe Action Script, ECMAScript, Standard Multimedia Scripting Language (SMSL), Lingo, and AVI-Mux. Analogously, the indicator can include any representation of a set of executable instructions; such as machine code instructions or byte code instructions, such as Java byte code.

Additionally or alternatively, the indicator can include non-executable data, such as an element of a markup based language, binary formatted data, and/or a link. For example, X3D is an ISO standard XML-based markup language for representing 3-D computer graphics includable in an MPEG media stream. Synchronized Multimedia Language (SMIL) is another exemplary markup-based language providing instructions for multimedia presentation includable in a media stream. A markup-based language sub-stream can include instructions defined in the particular markup-based language of the sub-stream as commands to access a shared resource. The markup can directly and/or indirectly indicate an association between the shared resource and a concurrency policy.

According to an exemplary embodiment, when the media processing subsystem 310 receives the media steam 328, the de-multiplexer 312A can separate the media stream into sub-streams by, for example, content type, and each sub-stream can be passed to a compatible decoder 312B for processing. When the indicator includes a script instruction, for example, a script stream decoder 312B can be configured to detect the script instruction. Similarly, when the indicator includes an element of a markup based language, a markup based language stream decoder 312B compatible with a particular markup based language can be configured to detect markup instructions and provide for processing the instructions according to the meaning of the markup instructions based on a schema defining the markup based language's syntax and semantics.

The detected indicator can be provided to a compatible content handler 312D configured to process the indicator by processing the executable data, e.g., script instructions, or non-executable data, e.g., markup instructions, in the indicator. According to an exemplary embodiment, the content handler 312D invokes directly or indirectly the concurrency agent 302 to detect an association between the resource to be accessed and a concurrency policy. For example, a script stream content handler 312D can process a portion of a script including an instruction requesting an identified lock when executed. The content handler 312D can invoke the concurrency agent 302 directly to detect the association, identifying the lock. Based on the information received by the concurrency agent 302, such as a lock identifier, the concurrency agent 302 can detect the association between the resource to be accessed and the concurrency policy.

Alternatively, the concurrency agent 302 can be invoked to detect the association indirectly, i.e., absent a call or message from the content handler 312D. For example, in one embodiment, the concurrency agent 302 can be configured to intercept any attempt by a module processing the media stream 328 to access a remote resource. Alternatively, the concurrency agent 302 can be a routine for accessing the remote resource. An association between a resource and a concurrency policy can be detected, in one embodiment, indirectly based on information in a response from a provider of the resource, a time in waiting for access to the resource, and/or information for accessing the resource from a resource provider returned in response to an attempt to access the resource by the concurrency agent 302.

In another embodiment, the concurrency agent 302 can retrieve policy information associated with the resource from a remote and/or a local data store and determine the concurrency policy based on the retrieved policy information. Alternatively or additionally, input information when detected by a concurrency agent 302, can identify and/or indicate an association between a concurrency policy and a resource. The input information can be associated with a hotspot, a particular location in presented content, player attributes, an identified user, a compositor, content of previous or future frames, and/or content of another sub-stream.

Example 1, below, illustrates an exemplary indicator providing an indication to access a shared resource. The indicator includes XML-based markup identifying a resource to be accessed by a process processing a media stream 328. The markup is a link element and no concurrency policy is explicitly associated.

### EXAMPLE 1

```
<overlay>
    <link ref=”http://resourceprovider.net/overlay13.jpg>
    <frames>143</frames>
    <topleft>43,257</topleft>
    <height>100</height>
    <width>100</width>
</overlay
```

In Example 1, the XML markup conforms to a corresponding schema that specifies an <overlay> element that can identify a visual overlay resource, in this case a JPEG image. The <overlay> element can include a <frames> element identifying a number of frames in which the overlay is to be presented and a location for presenting the overlay resource.

In one embodiment, a URL processor can be configured to operate as a concurrency agent 302. The URL processor can explicitly detect an association between the identified resource and a concurrency policy, as described above, or can detect the association indirectly and/or implicitly. For example, because the access reads the resource, a concurrency policy can be configured that allows concurrent reads, unless an attempt to update, delete, or otherwise write to or over the identified resource is granted. The concurrency policy can be enforced on a node, such as a node identified by the name “resourceprovider.net.”

A concurrency agent 302 can be a component for accessing the resource in another embodiment. When the concurrency agent 302 attempts an access during a write operation by a second process, a first process processing a first media stream can be placed in a wait state until either the resource is provided or information is provided that allows access. For example, the URL can identify the requested resource. Alternatively, it can identify a concurrency policy, and a response to a request for the URL can include a redirection to the resource when it is available for access by the first process processing the first media stream. Other concurrency policies can be associated with the resource including a policy that restricts the number of processes accessing a resource concurrently, transaction based policies, and transactional memory policies.

Example 2 also illustrates an exemplary indicator providing an indication to access a shared resource. In this case, a concurrency policy is specified and explicitly associated with the resource referenced by the <link> element.

### EXAMPLE 2

```
<overlay>
    <concurrency read=multiple write=single/>
    <link ref=”http://resourceprovider.net/overlay13.jpg>
    <frames>143</frames>
    <topleft>43,257</topleft>
    <height>100</height>
    <width>100</width>
</overlay
```

As stated above, the arrangement of components 200 for managing access to a resource can also be adapted for operation within a media processing node, shown in FIG. 5, that provides an execution environment 501 hosting a media service 500. In particular, the media service 500 can include a concurrency agent 502 configured to detect the association between a concurrency policy and a resource when the media service 500 is processing a media stream 526 for presentation. The media processing node hosting the media service 500 can be, in one embodiment, the media storage node 408, where a media stream 526 can be stored in a data store 530 and can be retrieved by the media processing subsystem 510 for processing and streaming to a recipient.

In one embodiment, a storage client 532 can be configured to interoperate with a storage subsystem 534 included in the execution environment 501. The storage subsystem 534 can be operatively coupled to one or more drivers providing communications and control of storage devices, such as the data store 530. The media service 500 can read the media stream 526 stored in the data store 530 via an interface of the storage subsystem 534. The storage client 532 can be configured to provide the data representing the media stream 526 to the media processing subsystem 510 for processing and for sending over the network 406 to the recipient, such as the a media player 402. A recipient can request a particular media stream 526 and/or a media stream 526 can be sent by the media service 500 to a recipient unsolicited and/or at the request of a node other than the recipient.

Alternatively or additionally, the media processing node hosting the media service 500 can be a multicast streaming service or a CDN service as hosted by the multicast streaming node 410 or the CDN node 412, respectively, each providing a proxy service. As a proxy service, the media service 500 can receive a media stream 526 sent over the network 406 via a network subsystem 524 operatively coupled to the network 406. The network subsystem 524 can route received media stream data to a port opened by the media service 500 for receiving a connection request and/or datagrams. Regardless of the transport and/or application protocol provided by the network subsystem 524 to receive a media stream, the media service 500 can include a network client 536 configured to interoperate with an interface provided by a layer of a network stack included in the network subsystem 524.

According to an exemplary embodiment, the media processing subsystem 510 can include at least one encoder 512A, a multiplexer 512B, a buffer manager 512C, and at least one content handler 512D. As with decoders 312A in media players 300, the media service 500 can include at least one encoder 512A, for example, for each of video data, audio data, metadata, markup-based language data, and/or script data as well as other types of executable data. Some encoders 512A can encode media stream data regardless of the data's attributes. For example, all the data in a media stream can be encrypted by a single encoder 512A configured to encode the data into an encrypted data stream. Other encoders 512A can be provided that process only a portion of the media stream's data. Media stream data can be provided to an encoder 512A based on the data's MIME type, for example.

An encoder 512A can be supported by a compatible content handler 512D. The content handler 512D can be invoked by the corresponding encoder 512A to examine the data processed by the encoder 512A and to perform operations. The content handler 512D can, for example, decode sub-stream data, if necessary, process the data, then encode the data or provide the decoded data to the encoder 512A for encoding. Although shown as a separate module from the encoder 512A, the content handler 512D can also be integrated within the encoder 512A.

In one embodiment, the received media stream 526 can be processed by the storage client 532 and/or network client 536 to identify one or more sub-streams included in the media stream 526. The storage client component 532 and/or network client 536 can be configured to detect each sub-stream and determine its type. The storage client 532 and/or the network client 536 can be further configured to provide a sub-stream to a stream encoder 512A configured to encode the sub-stream of the type determined.

Encoded data can be associated with a frame identified in the sub-stream and/or a frame identified in the media stream 526 external to the sub-stream. Encoded data and frame information can be provided to the multiplexer 512B. The multiplexer 512B can be configured to multiplex encoded data from one or more sub-streams into frame data representing a frame in a format suitable for transmission over a network. The multiplexer 512B provides portions of the multiplexed media stream to the buffer manager 512C, which can interoperate with the network subsystem 524 to transmit buffered data over the network 406 to the recipient.

According to an exemplary embodiment, the received media steam 526 can include the indicator that provides an indication to access the shared resource, as described above. The indicator can be included in a sub-stream of the media stream 526 and/or in a header or other portion not included in a sub-stream of the media stream 526. The detection of the association between a resource to be accessed and a concurrency policy can be based on the processing of the indicator by a process processing the media stream 526. In one embodiment, any of the media processing modules 512A-D in the media processing subsystem 510 can be configured to process the indicator.

As described above, the concurrency agent 502 can be invoked directly by a media processing module 512A-D in response to processing the indicator. Alternatively, the concurrency agent 502 can be invoked indirectly, as described above. Alternatively or additionally, at least a portion of the concurrency agent 502 can be included in a media processing module 512A-D. The detection by the concurrency agent 502 identifies and/or indicates an association between a shared resource to be accessed and a concurrency policy, as described above.

Referring again to FIG. 1, once the association is detected, the process continues in block 102 by listening for a message providing access to the shared resource based on an evaluation of the concurrency policy. According to an exemplary embodiment, the system for managing access to a resource includes means for listening for the message providing access to the shared resource. For example, FIG. 2 depicts a message receiver 206 configured for listening for the message providing access to the shared resource based on an evaluation of the concurrency policy.

In one embodiment, when the indicator providing the indication to access the resource is processed, a request to access the resource can be generated and sent to a resource provider. The request can identify the resource, the concurrency policy, and/or the association. Additionally, the request can be a request for a semaphore, lock, and/or other token indicating the resource is accessible. The request can include at least a portion of the concurrency policy associated with the requested resource. In each scenario involving a request to access the resource, the message receiver 206 can be configured to listen for a corresponding response. Alternatively or additionally, the message receiver 206 can be configured to listen for a response to a request polling for the message providing access to the shared resource.

For example, in one embodiment, a content handler 312D, 512D can, in response to processing an indicator for accessing the resource, request access to a resource. The request can be intercepted or otherwise received by the concurrency agent 302, 502 and/or can be provided to a message transmitter 352, 552 configured to prepare the request for sending via the network subsystem 324, 524 according to a protocol supported by the message transmitter 352, 552 and/or the network subsystem 324, 524. In response to sending the request, the concurrency agent 302, 502 can instruct the message receiver 306, 506 to listen for a response to the request. Alternatively, the concurrency agent 302, 502 can automatically instruct the message receiver 306, 506 to listen for a response to a request generated and sent by the message transmitter 352, 552 based on a detected association between a resource and a concurrency policy.

In another embodiment, a media processing module 212 processing a media stream can be configured to access a resource whenever the resource is available. A subscription can be sent to a resource provider, and/or a node operating to determine whether and when a resource is available. The message receiver 206 can be configured to listen for one or more asynchronous messages providing access to the resource. Alternatively, a resource provider can be configured to send an unsolicited message to the message receiver 206 providing access to the shared resource. The message receiver 206 can be configured, e.g., through information detected in the media stream being processed and/or through configuration information, to listen on one or more identified communication endpoints for an unsolicited, asynchronous message.

For example, in the media player 300 or the media service 500, at least one of the media processing modules, e.g., the content handler 312D, 512D, can process the indicator in a media stream. In addition to providing the indication to access the resource, the indicator, in one embodiment, can also identify a resource provider and an indication of one or more operations to perform when the resource is accessible. The content handler 312D, 512D can provide the identified resource provider and optionally the resource information to the concurrency agent 302, 502. The concurrency agent 302, 502 can receive this information and can send a message for establishing a subscription to be notified when the resource is accessible. The subscription message can be provided to the message transmitter 352, 552 to prepare and to send to a subscription server, such as a publish/subscribe server and/or a resource provider, over a network via the network subsystem 324, 524. The concurrency agent 302, 502 can be configured further to invoke the message receiver 306, 506 to establish a communication endpoint, such as a TCP and/or UDP port, to listen for a notification message providing access to the shared resource.

In addition, the concurrency agent 302, 502 can provide information to the message receiver 306, 506 to listen for unsolicited, asynchronous messages providing access to the resource associated with the concurrency policy. The concurrency agent 302, 502 can detect an association between a resource and a concurrency policy based solely on receiving a message providing access to a resource. The association can be identified in the message or can be implicit.

In another exemplary embodiment, a first stage of a concurrency policy can provide access to a resource in response to any request. The message receiver 206 can listen for and receive a response providing access to the resource in most cases without a delay in response to the resource being accessed by another process. The concurrency policy can have a second stage that when evaluated indicates that concurrency problems are to be detected by a monitor. The message receiver 206 can be configured to listen for a message from the monitor indicating a concurrency problem has occurred. This model can be viewed as analogous to transactional memory systems.

In yet another embodiment, a transaction manager can be provided to monitor accesses to shared resources based on a concurrency policy. If a concurrency problem allowed by the policy is detected, the transaction manager can be configured to send a message. The message receiver 206 can be configured to listen for a message from the transaction manager monitoring access to a shared resource.

According to an exemplary embodiment, access to the resource is based on an evaluation of the concurrency policy. The concurrency policy can be based on any detectable information including a type of access (read, write), a type of a resource, a security requirement, and/or a type of node and/or application accessing and/or attempting to access a resource. The concurrency policy can be maintained and/or enforced by a provider of an associated resource, a process processing a media stream including accessing an associated resource, and/or another node and/or application that neither provides the resource nor processes the media stream. The concurrency policy can also be provided in a media stream, in a process processing a media stream including a media player 300 and/or a media service 500, and/or in a data store maintained by a node and/or application that neither provides a resource nor processes a media stream.

The concurrency policy can be received via input provided by a user and/or generated automatically based on an attribute of, for example, the resource, an accessing media stream, and/or an accessing node.

According to one embodiment, the processing of the media stream 328, 526 can be suspended when the association is detected and/or while the message receiver 306, 506 is listening for the message providing access to the shared resource. The suspended process can be restarted and/or aborted when the listening for the message exceeds a predetermined time.

Referring again to FIG. 1, in block 104, the message providing access to the shared resource is received. According to an exemplary embodiment, the system for managing access to a resource includes means for receiving the message. For example, the message receiver 206 can be configured for receiving the message providing access to the shared resource.

According to an exemplary embodiment, the message providing access to the shared resource can be a response to a request to access the shared resource, a notification message relating to a subscription to determine whether the resource is available, and/or an unsolicited asynchronous message. The message providing access can include a reference to the resource, e.g., a URL, an identifier identifying a communication endpoint for listening for a message including at least a portion of the resource, a reference for accessing the resource, and/or an indication that the resource is available. In the latter case, the resource can be located based on information detected during processing of the media stream as described above.

When the resource is not included in the received message, a request can be made to access the resource and a corresponding response including at least a portion of the resource can be received by the message receiver 206. When a first message received does not include at least a portion of the resource requiring a second received message to be received including at least a portion of the resource, the first and second received messages can be formatted according to the same protocol or different protocols. Both messages can be responses to requests, notifications associated with subscriptions, or asynchronous messages. Alternatively, the first and second messages can be received according to a different message flow model than the other. For example, the first received message can be a response to a request. The response can identify a communication endpoint to listen for a second message including at least a portion of the resource.

Referring again to FIG. 1, in response to receiving the message, the shared resource is accessed in block 106. According to an exemplary embodiment, the system for managing access to a resource includes means for accessing the shared resource in response to receiving the message. For example, a media processing module 212 can be configured for accessing the shared resource in response to receiving the message.

According to an exemplary embodiment, in response to receiving the message, the message receiver 206 can provide the message to a compatible media processing module 212 via the concurrency agent 202. For example, the concurrency agent 202 can provide the message to the compatible media processing module 212 based on an attribute of the data, e.g., MIME type, or according to instructions received from a media processing module 212 and/or the concurrency agent 202. In one embodiment, the media processing module 212, e.g., the content handler 312D, 512D can receive the message and access the shared resource. For example, the content handler 312D, 512D can send a request for the resource and receive a corresponding response including at least a portion of the resource.

The media processing module 212 can be configured to process at least a portion of the media stream 328, 526 based on the accessed shared resource. In one embodiment, the presentation of the media stream 328, 526 can be altered based on the accessed shared resource. For example, the accessed resource can be a command to speed up the presentation of the media stream 328, 526, and/or to alter the content, size, a color, a text portion, and/or any other attribute of the presentation. The altering of the presentation of the media stream 328, 526, can also include generating a presentable representation of the shared resource that can be presented along with at least a portion of the presentation of the media stream 328, 526, or replacing presentation of media stream with accessed resource.

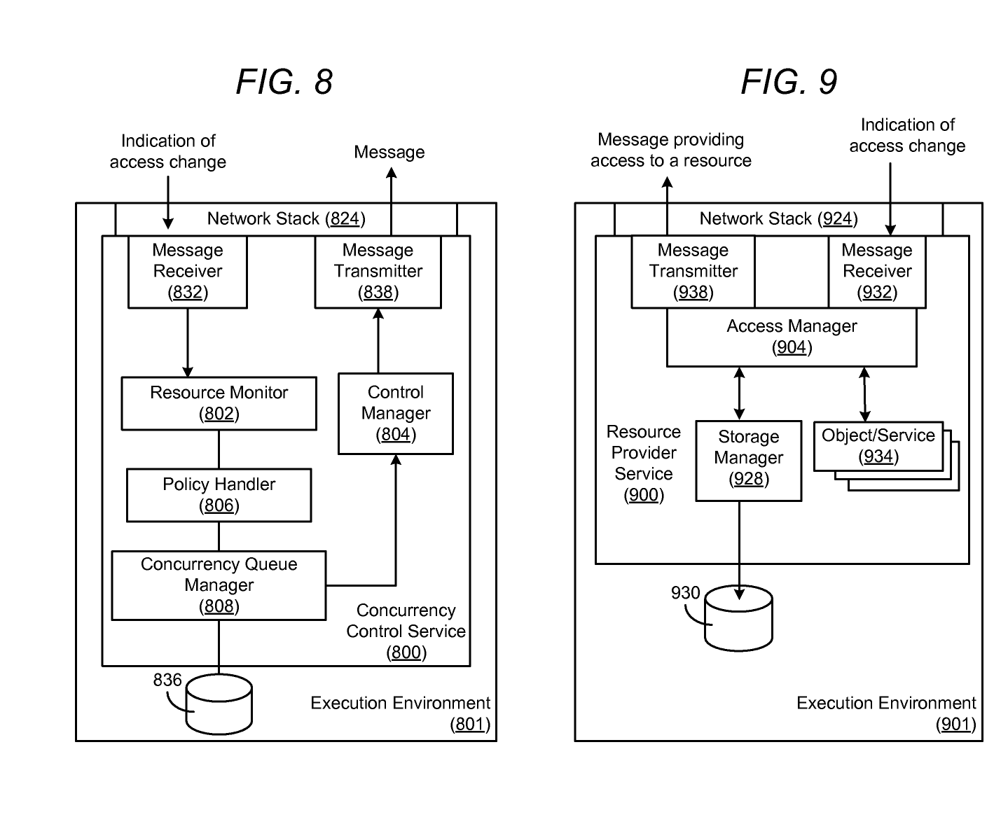

FIG. 6 is a flow diagram illustrating a method for managing access to a resource according to another aspect of the subject matter described herein. FIGS. 7 and 8 are block diagrams illustrating systems for managing access to a resource according to other embodiments. In particular, FIG. 7 is a block diagram illustrating an arrangement of components configured for managing access to a resource, while FIG. 8 illustrates a node that provides an execution environment configured for hosting at least some of the components illustrated in FIG. 7. The method illustrated in FIG. 6 can be carried out by, for example, some or all of the components illustrated in FIG. 7 operating in a compatible execution environment provided by some or all of the components of the arrangement in FIG. 8.

As stated above, the arrangement of components 700 illustrated in FIG. 7 is configured to operate within an execution environment hosted by a node and/or multiple nodes. For example, a resource concurrency controlling node, such as a concurrency control node 414, can be configured to provide an execution environment, described above, adapted to support the operation of the arrangement of components 700 in FIG. 7.

Illustrated in FIG. 8 is a resource concurrency controlling node that provides an execution environment 801 hosting a concurrency control service 800 including the arrangement of components 700 illustrated in FIG. 7. The execution environment 801, or an analog, can be provided by a node such as a concurrency control node 414 and/or the media storage node 408. The concurrency control service 800 is configured for regulating access to a shared resource by at least one process processing a media stream based on a concurrency policy associated with the resource.

Referring to FIG. 6, in block 600, the process begins when a change in access by a process to a shared resource is detected. In one embodiment, the shared resource can be shareable by a plurality of processes, at least some of which are processing a media stream. According to an exemplary embodiment, a system for managing access to a resource includes means for detecting a change in access by a process to a shared resource. For example, FIG. 7 depicts a resource monitor component 702 configured for detecting the change in access by a process to a shared resource.

According to an exemplary embodiment, the resource monitor component 702 can be configured to detect a change in access to a shared resource via access information provided by messages from remote nodes accessing the shared resource and/or nodes having knowledge of shared resource access by another node. The access information in the message can include an indication for accessing, releasing, and/or attempting to access the shared resource. In one embodiment, the resource monitor component 702 can receive the message from a media processing node, e.g., the player node 402, the multicast streaming node 410 and/or the CDN node 412, accessing, releasing, and/or attempting to access the shared resourced.

In another embodiment, the resource monitor component 702 can receive the message from a resource provider in, for example, the media storage node 408 and/or a node hosting a proxy between a media processing node, e.g., player node 402, and a media storage node 408 indicating a change in access to a shared resource. Illustrated in FIG. 9 is a node that provides an execution environment 901 hosting a resource provider service 900 that provides access to a plurality of shared resources. The execution environment 901, or an analog, can be provided by a node such as the media storage node 408. Alternatively, the resource provider service 900 can be hosted by an execution environment 901 provided by the concurrency control node 414. In such an arrangement, the concurrency control service 800 and the resource provider service 900 can be co-hosted by the same execution environment in the same node.

In one embodiment, an access manager component 904 can be configured to manage access to the shared resources including active executable object/services 934 and resource data stored in a data store 930. The access manager component 904 can receive a message from a media processing node requesting access to a resource over a network 406 via a network subsystem 924 operatively coupled to the network 406. The access manager 904 can provide access information to the resource monitor 802 in response to the requested access and/or at the request of the resource monitor 802 polling the access manager 904. Additionally, the access manager component 904 can be configured to automatically notify the resource monitor 802, for example, when access to a resource is provided, when access to a resource has ended, and/or when an event affecting access to the shared resource is detected.

In an exemplary embodiment, the resource monitor component 802 in the concurrency control service 800 can receive the message including access information via the network stack 824 and via a communication endpoint associated with a message receiver 832. The communication endpoint can be identified for receiving access information associated with the shared resource. The message receiver 832 can be configured to provide the information to the resource monitor 802. Based on the received information, the resource monitor 802 can detect a change in access to the shared resource. For example, detecting the change can include, but not be limited to, detecting: a time period for automatically releasing a resource being accessed by a process, a higher priority requester, a number of accesses by another process, an update to the resource and/or a related resource, a use count, and/or an exclusive lock.

Referring again to FIG. 6, when the change in access to the shared resource is detected, a concurrency policy controlling an order of access to the shared resource is evaluated in block 602. According to an exemplary embodiment, a system for managing access to a resource includes means for evaluating a concurrency policy controlling an order of access to the shared resource. For example, FIG. 7 depicts a policy handler component 706 configured for evaluating the concurrency policy.

According to one embodiment, the policy handler 706 can be invoked by the resource monitor 702 in response to detecting a change in access to a shared resource. Alternatively, the policy handler 706 can poll the resource monitor 702 for access information associated with a shared resource. The policy handler 706 can be configured, in one embodiment, to evaluate a particular policy associated with a particular resource. Alternatively or additionally, the policy handler 706 can receive a concurrency policy and/or access information associated with the shared resource.

In another embodiment, the policy handler 706 can detect or otherwise receive policy evaluation parameters that are associated with a process accessing, releasing, and/or attempting to access the shared resource. The policy handler 706 can identify another shared resource being accessed by the process accessing, releasing, and/or attempting to access the resource. Evaluation parameters can be any information accessible and/or provided to the policy handler 706.

The policy handler 706 can determine, in one embodiment, whether a detected change in access warrants an evaluation of the concurrency policy and/or an updating of associated data, such as a lock count. When a policy evaluation is deemed necessary, the policy handler 706 can evaluate a concurrency policy in an association between the policy and a particular shared resource associated with the detected change in access. According to one embodiment, the execution environment 801 that hosts the concurrency control service 800 can include a data store 836 for storing concurrency policies and access information. The policy handler 806 can retrieve the concurrency policy from the data store 836 for evaluation. Alternatively or additionally, the concurrency policy or a portion of the concurrency policy can be included in the access information of the received message.

As discussed above, the concurrency policy determines an order of access to the shared resource by one or more processes. The order of access can be fixed or dynamic and can be based on at least one of an order of access request, a priority associated with a process, an owner of a process, a network address of a process, and/or a number of previous accesses by a process. In some cases, the concurrency policy can serialize access to a resource, allow multiple readers while serializing writes to a resource, and/or allow multiple readers and writers, detecting problems during and/or after an access. A concurrency policy can be enforced via a lock, a semaphore, and/or token.

Referring again to FIG. 6, in block 604, a next process of at least one process processing a media stream and waiting to be allowed access to the shared resource is determined based on the concurrency policy. According to an exemplary embodiment, a system for managing access to a resource includes means for determining, based on the concurrency policy, a next process of at least one process processing a media stream and waiting to be allowed access to the shared resource. For example, FIG. 7 depicts a concurrency queue manager component 708 configured for determining the next process.

According to one embodiment, the concurrency queue manager component 708 can determine the next process based on the evaluation of the concurrency policy, which determines the order of access. As stated above, the concurrency policies can be stored in the data store 836 and managed by the concurrency queue manager component 808. In one embodiment, the order of access can be preconfigured, such as with a first in/first out (FIFO) process or a priority based process where a priority can be associated with each waiting process. Time can also be a variable for affecting a process' priority. Alternatively, the order of access can be dynamic. For example, a resource's association with a concurrency policy can change based on any number of accessible attributes such as time of day, processor utilization, a system security level, and the like.

When one or more processes require access to the resource, the concurrency queue manager 808 can determine a next process of the one or more waiting processes based on an evaluation of the concurrency policy. For an FIFO policy, a process identified at the end of a wait queue can be determined to be a next process to be allowed access. When the policy determines a next process randomly, a next process can be determined based on a random selection. When only one process is waiting and all access conditions are met, it is determined to be the next process. When a concurrency policy allows multiple concurrent readers and the next process is only reading the resource, one or more additional processes can be determined to be allowed access so long as they are only reading the resource. In one embodiment, determining the next process can also include authenticating and evaluating a status of the processes waiting to access the resource.

When a process is to be provided access, and the resource is available, the policy handler 806 and or the concurrency queue manager 808 can determine, based on the evaluation of the concurrency policy, whether the process should be provide access immediately or whether the process must wait for another condition to be satisfied. For example, the condition can allow other processes with higher priorities to access the resource first, and/or the process can require access to a second resource along with the resource to be accessed concurrently, as in a transaction. In the latter case, when the second resource is not available, the process can be placed in a wait state with an order of access determined by evaluation of an associated policy or an order of access to be determined based on an evaluation of the policy in response to detecting another change in access associated with the second resource.

In another example, when a first process is to be provided access to a resource that is not available, the policy handler 806 and or the concurrency queue manager 808 can determine based on the evaluation of the policy that the first process has priority over a second process currently accessing the resource. The second process' access can be terminated by the concurrency queue manager 808. The second process can receive a message indicating the termination of access and/or receive an error message during processing or attempted processing of the resource. The second process can be configured to retry processing requiring access to the resource, can ignore the error, and/or can fail. Alternatively, the first process can be required to wait. The wait can depend on whether other processes are also waiting and can include consideration of attributes of the waiting processes and/or any other attribute included in policy evaluation.

Referring again to FIG. 6, when the next process is determined, the method includes providing for access to the shared resource to the determined next process for processing the media stream including accessing the shared resource in block 606. According to an exemplary embodiment, a system for managing access to a resource includes means for providing for access to the shared resource to the determined next process for processing the media stream including accessing the shared resource. For example, FIG. 7 depicts a control manager component 704 configured for providing for access to the shared resource to the determined next process.

According to one embodiment, the control manager 704 can receive an indication identifying the determined next process and the resource from the concurrency queue manager 708. Identification of either can be explicit or implicit and direct or indirect. In response to receiving the indication, the control manager 704 can be configured for providing for access to the shared resource.

In one embodiment, a message indicating the resource is accessible can be generated and sent to the node hosting the determined next process. In the concurrency control service 800, the control manager 804 can send the message using a message transmitter 838 configured to format and/or otherwise prepare the message for transmission over the network 406 via the network stack 824. The message can be sent in response to a request to access the resource, be sent as an asynchronous, unsolicited message to the node of the determined next process, and/or be sent as a notification associated with a subscription for accessing the resource.

In one embodiment, the message can include a location for accessing the resource so that the node of the determined next process can retrieve the resource. Alternatively or additionally, the message can include an access identifier such as a URL. Security information can be provided allowing the next process access and authorizing a particular set of capabilities. In one embodiment, the message can include an identifier identifying a communication endpoint for listening for another message including at least a portion of the resource. Further, the message can include at least a portion of the resource. According to an exemplary embodiment, the control manager 804 can be configured to inform a node that access is not currently available, and can provide information on the requestor's place in a current order of access between or among a plurality of requesting nodes with respect to a shared resource.

Alternatively or additionally, the control manager 804 can provide for access to the resource by, for example, sending a message to the node hosting the resource provider service 900. The message can include a reference to the resource and can direct the resource provider service 900 to provide access to the resource. When the message from the concurrency control service 800 is received, the access manager 904 can retrieve the resource from the data store 930 via a storage manager 928, and send a message providing access to the resource to the node hosting the determined next process, e.g., a media player 300 or media service 500.

In one embodiment, the concurrency agent 302, 502 in the media player 300 or media service 500 can operate along with the resource provider service 900 to provide concurrent access to a shared resource by multiple processes. Each process can be processing a distinct instance of a media stream. A concurrency manager or monitor included in and/or interoperating with the resource provider service 900 can detect a concurrency problem after the message providing access to the resource is received by the concurrency agent 302, 502. The situation is analogous when access to a shared resource is monitored by a transaction manager. Here, a received message can provide access to a shared resource while other processes are accessing the same resource. Concurrency errors can be detected by the transaction manager after the message providing access to the shared resource is received by the concurrency agent 302, 502

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, the methods described herein can be embodied in executable instructions stored in a computer readable medium for use by or in connection with an instruction execution machine, system, apparatus, or device, such as a computer-based or processor-containing machine, system, apparatus, or device. As used here, a “computer readable medium” can include one or more of any suitable media for storing the executable instructions of a computer program in one or more of an electronic, magnetic, optical, electromagnetic, and infrared form, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

Thus, the subject matter described herein can be embodied in many different forms, and all such forms are contemplated to be within the scope of what is claimed. It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for managing access to a resource, the method comprising:
detecting, during processing of a first media stream by a first process for presentation, an association between a concurrency policy and a shared resource shareable with a second process;
listening for a message providing access to the shared resource based on an evaluation of the concurrency policy;
receiving the message providing access to the shared resource; and
accessing the shared resource in response to receiving the message.

2. The method of claim 1 wherein the detecting the association is based on processing by the first process an indicator, included in the first media stream, the indicator providing an indication to access the shared resource.

3. The method of claim 2 wherein the indicator includes executable data.

4. The method of claim 3 wherein the executable data includes a script instruction.

5. The method of claim 2 wherein the indicator includes non-executable data.

6. The method of claim 5 wherein the non-executable data includes an element of a markup based language.

7. The method of claim 2 wherein the indicator is included in a substream of the first media stream.

8. The method of claim 2 wherein the indicator identifies at least one of the shared resource and the concurrency policy.

9. The method of claim 2 wherein detecting the association includes retrieving, in response to processing the indicator, policy information associated with the resource and determining the concurrency policy based on the retrieved policy information.

10. The method of claim 1 wherein the concurrency policy includes at least one of a lock or a semaphore.

11. The method of claim 1 further comprising:
generating a request identifying at least one of the resource, the concurrency policy, and the association; and
sending the request to access the resource.

12. The method of claim 11 wherein listening for the message includes listening for a response to the request to access the resource.

13. The method of claim 1 wherein the message providing access to the shared resource is at least one of a response to a request to access the shared resource, a notification message relating to a subscription to determine whether the resource is available, and an unsolicited asynchronous message.

14. The method of claim 1 wherein the message providing access includes at least one of a reference to the resource, an indication that the resource is available, an identifier identifying a communication endpoint for listening for a message including at least a portion of the resource, and a portion of the resource.

15. The method of claim 1 further comprising altering a presentation of the first media stream based on the accessed shared resource.

16. A method for managing access to a shared resource, the method comprising:
detecting a change in access by a process to a shared resource;
evaluating a concurrency policy controlling an order of access to the shared resource;
determining, based on the concurrency policy, a next process of at least one process processing a media stream and waiting to be allowed access to the shared resource; and
providing for access to the shared resource to the determined next process for processing the media stream including accessing the shared resource.

17. The method of claim 16 wherein detecting the change in access to the shared resource includes receiving a message for at least one of accessing, releasing, and attempting to access the shared resource, wherein the message is received via at least one of a node accessing the resource, a node providing the resource, and a proxy for at least one of the accessing node and the providing node.

18. The method of claim 16 wherein detecting the change includes detecting an event that affects access to the shared resource.

19. The method of claim 16 wherein evaluating the concurrency policy includes using policy evaluation parameters associated with a process that is at least one of accessing, releasing, and attempting to access the shared resource.

20. The method of claim 16 wherein the order of access is based on at least one of an order of access request, a priority associated with a process, an owner of a process, a network address of a process, and a number of previous accesses by a process.

21. The method of claim 16 wherein determining the next process includes authenticating the at least one waiting process, and evaluating a status of the at least one waiting process.

22. The method of claim 16 wherein providing for access to the shared resource includes sending a message indicating the shared resource is accessible to a node hosting the determined next process.

23. The method of claim 22 wherein the message includes at least one of a reference to the resource, an indication that the resource is available, an identifier identifying a communication endpoint for listening for a message including at least a portion of the resource, security information, and a portion of the resource.

24. The method of claim 22 wherein the message is at least one of a response to a request to access the shared resource, a notification message relating to a subscription to determine whether the resource is available, and an unsolicited asynchronous message.

25. A computer readable medium containing a computer program, executable by a machine, for managing access to a resource, the computer program comprising executable instructions for:
detecting, during processing of a first media stream by a first process for presentation, an association between a concurrency policy and a shared resource shareable with a second process;
listening for a message providing access to the shared resource based on an evaluation of the concurrency policy;
receiving the message providing access to the shared resource; and
accessing the shared resource in response to receiving the message.

26. A system for managing access to a resource, the system comprising:
means for detecting, during processing of a first media stream by a first process for presentation, an association between a concurrency policy and a shared resource shareable with a second process;
means for listening for and for receiving a message providing access to the shared resource based on an evaluation of the concurrency policy; and
means for accessing the shared resource in response to receiving the message.

27. A system for managing access to a resource, the system comprising:
a concurrency agent configured for detecting, during processing of a first media stream by a first process for presentation, an association between a concurrency policy and a shared resource shareable with a second process;
a message receiver configured for listening for and for receiving a message providing access to the shared resource based on an evaluation of the concurrency policy; and
a media processing module configured for accessing the shared resource in response to receiving the message.

28. A computer readable medium containing a computer program, executable by a machine, for managing access to a resource, the computer program comprising executable instructions for:
detecting a change in access by a process to a shared resource;
evaluating a concurrency policy controlling an order of access to the shared resource;
determining, based on the concurrency policy, a next process of at least one process processing a media stream and waiting to be allowed access to the shared resource; and
providing for access to the shared resource to the determined next process for processing the media stream including accessing the shared resource.

29. A system for managing access to a resource, the system comprising:
means for detecting a change in access by a process to a shared resource;
means for evaluating a concurrency policy controlling an order of access to the shared resource;
means for determining, based on the concurrency policy, a next process of at least one process processing a media stream and waiting to be allowed access to the shared resource; and
means for providing for access to the shared resource to the determined next process for processing the media stream including accessing the shared resource.

30. A system for managing access to a resource, the system comprising:
a resource monitor configured for detecting a change in access by a process to a shared resource;
a policy handler configured for evaluating on a concurrency policy controlling an order of access to the shared resource;
an concurrency queue manager configured for determining, based on the concurrency policy, a next process of at least one process processing a media stream and waiting to be allowed access to the shared resource; and
a control manager configured for providing for access to the shared resource to the determined next process for processing the media stream including accessing the shared resource.
